(19) United States
(12) Patent Application Publication
(10) Pub. No.: US 2024/0058643 A1
(43) Pub. Date: Feb. 22, 2024

(54) MACHINE WASHABLE EXERCISE MAT DEVICE

(71) Applicant: Shoaib Khadri, Naperville, IL (US)

(72) Inventor: Shoaib Khadri, Naperville, IL (US)

(21) Appl. No.: 18/466,581

(22) Filed: Sep. 13, 2023

(51) Int. Cl. A63B 21/00; B32B 5/24; B32B 33/00; B32B 7/12; B32B 7/09; B32B 43/00

(52) U.S. Cl. CPC A63B 21/4037; B32B 5/24; B32B 33/00; B32B 7/12; B32B 7/09; B32B 43/003; B32B 2307/726; B32B 2307/7265; B32B 2262/065; B32B 2262/0276; B32B 2262/04; B32B 2262/14; B32B 2255/02; B32B 2255/26; B32B 2307/737

(57) ABSTRACT

This invention is a multilayered mat with each layer integrated with each other by different means of attachments including, but not limited to quilting, fusing, etc. The invention is designed specifically for exercise mat use such as yoga, pilates and other exercises. Additionally, it includes variation of a design that is custom cut tailored for exercise machine usage such as the pilates machine. The invention is designed to withstand multiple washes in a conventional washer and dryer for home, commercial or industrial applications. It is reusable after numerous washes since it retains the original quality without degradation. The invention is designed as an absorbent, leak-proof, washer/dryer sale, and skid proof device.

### FIELD OF THE INVENTION

The present invention relates generally to the fields of exercise performed on the floor as well as on machines, particularly in the practice of yoga, hot yoga, pilates and other exercises.

The invention relates to an absorbent, leak-proof, cushioned, skid-resistant multi-layered arrangement which is safe for washer and dryer at high temperatures. The primary application of the invention serves as a mat on which different types of exercises are performed, including yoga in its multiple variations. The thick, multilayered construction is designed for comfort of the user even on hard surfaces such as ceramic tile, PVC tiles, hardwood, etc. The design provides a skid resistant surface enabling performance of the yoga exercises without shifting or wrinkling. The surface of the invention uses an absorbent fabric that absorbs sweat from the body at all contact points. One of the variations of the design also provides a grip feature such that sweaty palms or feet on contact with the mat do not slide during exercise routine.

### BACKGROUND INFORMATION

The ancient Indian tradition of yoga has become increasingly popular across the entire world due to its proven advantages in leading a healthy lifestyle. Over the years, many mats have been developed in different sizes, material and thickness. But, all these mats have focused only on comfort and skid resistance and not on absorbency or hygiene—there is no effective way to clean current yoga mats thus making them dirty, smelly and unhygienic. As a result, many yoga mats are disposed off after a certain number of uses causing an environmental hazard by burdening the landfill. Moreover, the surface of most current yoga mats are not absorbent to absorb any sweat and the only solution to this problem is to use a yoga towel as an attachment to the standard yoga mat that can be removed and washed but the attachment is inefficient for performing exercises. This invention not only addresses the features for comfort, grip and skid resistance but additionally, provides the ability to easily clean in the washer and dryer as well as absorbent so that the sweat gets immediately absorbed during exercise.

The present invention has certain similarities to other existing patents and/or publications as detailed below. However, the prior art inventions are not designed to be machine washable. This invention is washable in the washing machines that include conventional washer and dryer at homes, commercial or industrial settings without damaging the fabric. The present invention of this application has many unique features and functionalities that make it uniquely distinguishable as explained in the bottom section.
a) Patent #: US20050192158A1—This invention provides composite yoga mats comprising a fabric sheet with a frictional material and/or loop holes to provide support, a stable surface, and moisture absorption for the practice of yoga.
b) Patent #: U.S. Pat. No. 9,610,472B2—Yoga mat devices which generally comprise a yoga mat having one or more storage compartment(s).
c) Patent #: US20170368407A1—The yoga mat system of claim 3 where said center portion of said first yoga mat is sized to allow two children to simultaneously practice yoga on its upper surface.
d) Patent #: CN108690363A—TPE Yoga mats foamed material according to claim 6, it is characterised in that: The step A is excessive dense It in sulfuric acid, is added in container, temperature is controlled at 4 DEG C by ice bath, the graphene of 100 mesh is added later, stone is being added later.
e) Patent #: CN206910657U It the utility model is related to a kind of TPU Yoga mats, including top layer, intermediate layer and bottom, the intermediate layer clamping is arranged between the top layer and the bottom, at least one layer in the top layer and the bottom includes sheet material, the sheet material includes at least one layer of platy layer, and the platy layer includes the bead of multiple TUP foamings mutually bonded.

### SUMMARY OF THE INVENTION

This present invention overcomes the deficiencies of prior art related to exercise mats or yoga mats with its uniquely distinguishing features and improvements as detailed below.

This present invention is safe for all types of conventional washers and dryers, including those with home, commercial or industrial use. It is designed to withstand high temperatures in the washing cycles and drying cycles.

This present invention includes a layer designed for skid resistance for stability and avoid sliding and skidding on any surfaces that it is used on.

This present invention includes gripping features on the facing fabric to allow performance of all exercise moves without slipping even with sweaty palms and feet.

This present invention includes custom-cut patterns for various exercises performed on the floor as well as on machines such as a pilates machine providing comfort, grip and machine washable feature.

### DETAILED DESCRIPTION OF THE DRAWINGS

The accompanying set of drawings illustrate the embodiment of the present invention, combined with the description below, serve to clearly explain the principles, construction, functionality, and arrangement of the invention.

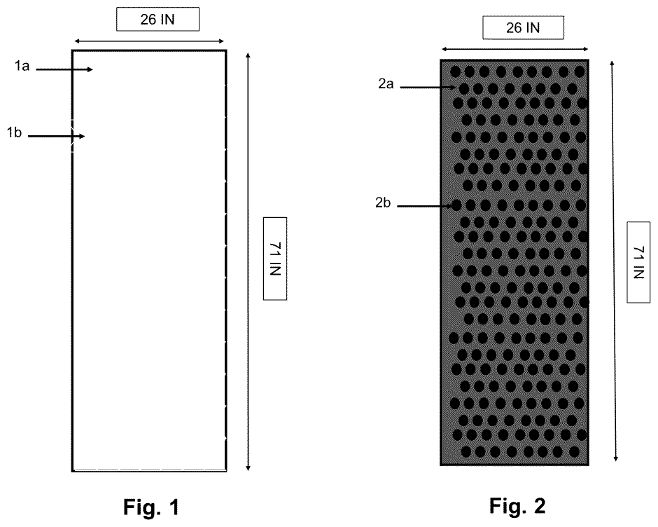

FIG. 1 is the top view of one embodiment of the invention which serves as an exercise mat custom cut for specific exercises. This figure shows the most popular size of a yoga mat which is 26 inches by 71 inches although the sizes could range between 20 inches and 30 inches in the width and between 65 inches and 90 inches in length. FIG. 1a shows the facing fabric of the device is made from a blend of Thermoplastic polyurethane (TPU) polyester of 70% to 100% of the blend and rayon of 1% to 30%. The blend can be a combination of other fibers like cotton, bamboo, etc. and other natural and man-made fibers to make sure that it has the feature of being absorbent, soft and not slippery. FIG. 1b points to the stitching on the entire device holds the multiple layers in place in a quilt stitch. The stitching pattern can be a straight diamond, a curved diamond or a wave pattern

FIG. 2 depicts the bottom view of this embodiment of the invention. FIG. 2a showing the bottom fabric layer that is made of silicone or could be any other similar material that has the specific functionality of making it non-slidable on the surface it is used on. FIG. 2b points to the silicone dots that are embedded in the bottom silicone layer during the manufacturing process in a pattern that are spaced in the correct configuration to give grip to the entire device so it does not slide or skid on the surface it is used on during different exercise cycles including simple and rigorous exercises.

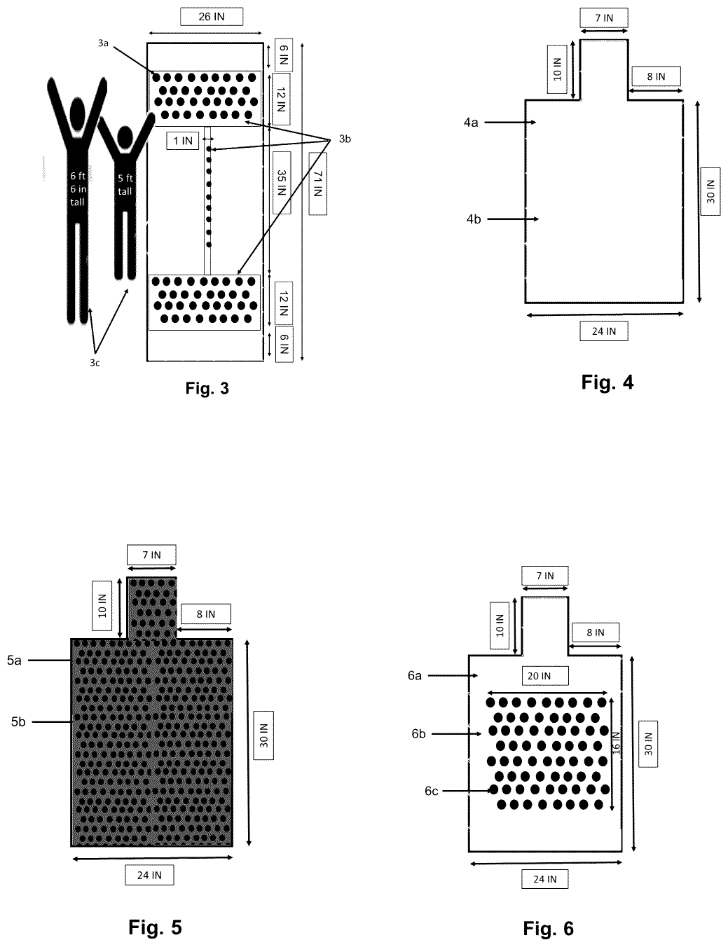

FIG. 3 shows the top view of an embodiment that is a variation with gripping dots on the top surface of the invention that is shown in FIG. 1. FIG. 3a points to the felt dots that are applied to the top surface layer of the device that provides a grip for the user so the palms and feet do not slide during the exercise routine, especially when their palms and feet are sweaty. The center row of dots is placed exactly at the center of the horizontal axis of the device to act as a guide for maintaining symmetry during the exercises. FIG. 3b depicts a configuration of dots that are applied to the surface of the device in a specific pattern designed for form and functionality. The top section of the dots are for the palms of the user and the bottom section is for the feet of the user. The size of each section as well as the spacing between the two sections has been calculated to accommodate a range of users whose height may vary between 5 feet and 6 feet 6 inches. FIG. 3c depicts user variation of a short person and a tall person in reference to the mat showing the practicality of users of varying heights being able to use the functionality of the device.

FIG. 4 shows the top view of an embodiment that is a variation of the invention that is custom cut for an exercise machine. This figure shows the standard shape and size of the mat that is used on the pilates machine. The shape and size can be configured for other exercise machines. FIG. 4a shows the facing fabric of the device made from a blend of TPU polyester and Rayon. The blend can be a combination of other fibers like cotton, bamboo, etc. to make sure that it has the feature of being absorbent, soft and not slippery. FIG. 4b The stitching on the entire device holding the multiple layers in place in a quilt stitch. The stitching pattern can be a straight diamond, a curved diamond or a wave pattern

FIG. 5 depicts the bottom view of this embodiment of this variation of the invention that is shown in FIG. 4. FIG. 5a showing the bottom fabric layer made of silicone or any other similar material that has the specific functionality of making it non-slidable on the surface it is used on. FIG. 5b points to the silicone dots that are embedded in the bottom silicone layer during the manufacturing process in a pattern that are spaced in the correct configuration giving a firm grip to the entire device preventing sliding or skidding on the surface it is used on during different exercise cycles including simple and rigorous exercises.

FIG. 6 shows the top view of an embodiment that is a variation with gripping dots on the top surface of the invention that is custom cut for the exercise machine as shown in FIG. 4. FIG. 6a depicts a configuration of dots that are applied to the surface of the device in a specific pattern designed for form and functionality. The configuration shown in this figure conforms to providing the grip for palms as well as for the back while lying on the surface during exercise. FIG. 6b points to the felt dots that are applied to the top surface layer of the device providing a firm grip for the user so the palms or back do not slide during the exercise routine, especially when the palms or back is sweaty. The size of the coated area is 20 inches wide and 40 inches long for a pilates machine.

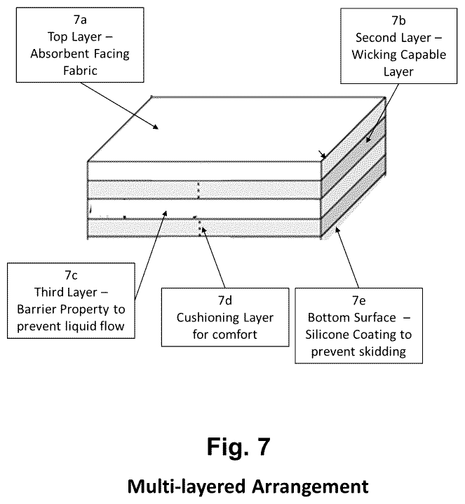

FIG. 7 shows the cross-sectional view of the device that applies to all variations of the invention that are shown in FIGS. 1 to 6. Each layer of this multilayered construction is detailed in this figure. The method for integrating these multiple layers is by means of applying heat and adhesive to attach the first three layers; by means of stitching in a quilt pattern; and coating the bottom layer with silicone and dots applied to the silicone layer. FIG. 7a shows the top Layer of soft fabric made from a blend of TPU polyester and Rayon. The blend can be a combination of other fibers like cotton, bamboo, etc. to make sure that it has the feature of being absorbent, soft allowing sweat to be absorbed and preventing liquid stagnation. FIG. 7b is made from a special grade of polyester that has a wicking property that enables the device to instantly dissipate any liquid without puddling thus making the facing fabric dry quickly. FIG. 7c identifies the protective barrier third layer wherein the leakproof layer is preventing liquid from seeping through the device thereby protecting a surface that is used. FIG. 7d a cushioning fourth layer wherein the fourth layer is maintaining a thickness for comfort. FIG. 7e shows the bottom anti-skid surface wherein the bottom surface has a special anti-skid coating with dots preventing the mat device from skidding on the surface that is used.

1. A custom cut exercise mat device configured as a machine washable dryable exercise mat of multilayered arrangement comprising:
a. a facing first layer soft fabric wherein the first layer is an absorbent surface allowing sweat to be absorbed and preventing liquid stagnation and a variation of this layer has a coating of felt dots on the surface for grip;
b. a wicking second layer wherein the second layer instantly dissipates any liquid by making the facing fabric dry quickly;
c. a protective barrier third layer wherein the third layer is preventing liquid from seeping through the device thereby protecting a surface that it is used on;
d. a cushioning fourth layer wherein the fourth layer is maintaining a thickness for comfort;
e. a bottom anti-skid fifth layer wherein the bottom layer has a special anti-skid coating with dots preventing the mat device from skidding on the surface that it is used on.

2. The custom cut exercise mat device of claim 1 wherein it is made from a combination blend of a natural fiber and a man-made fiber providing the blend absorbent property of the mat device.

3. The said natural fiber of claim 2 wherein the natural fiber is bamboo fiber for providing comfort and softness.

4. The said natural fiber of claim 2 wherein the natural fiber is cotton fiber for providing comfort and softness.

5. The said natural fiber of claim 2 wherein the natural fiber is rayon fiber for providing comfort and softness.

6. The said man-made fiber of claim 2 wherein the fiber is a polyester for providing strength and stability.

7. The custom cut exercise mat device of claim 1 wherein the layers are adhered to each other by means of an adhesive and bounded together by a quilt pattern formation stitching across all layers.

8. The custom cut exercise mat device of claim 1 wherein the anti-skid coating is silicone with dot configurations protruding outward for providing grip and skid resistance on the surface that is used upon.

9. The custom cut exercise mat device of claim 1 wherein the facing fabric has a plain surface without coating for specific types of exercises.

10. The custom cut exercise mat device of claim 1 wherein the facing fabric has a coating on the surface specific for certain types of exercises.

11. The said coating surface of claim 10 wherein the dots are made of felt protruding slightly from the surface wherein providing a firm grip for a user wherein preventing sweaty palms from sliding on the surface during exercise.

12. The said coating surface of claim 10 wherein the dots are felt dots protruding slightly from the surface wherein providing a firm grip for a user wherein preventing feet from sliding on the surface.

13. The said coating specific of claim 11 wherein an upper section of the mat has a special pattern coating for resting palms on the mat.

14. The said coating specific of claim 12 wherein a lower section of the mat has a special pattern coating for resting feet on the mat.

15. The said coating specific of claim 10 wherein a center line serves as a guideline for maintaining symmetry during exercise.

16. The said coating specific of claim 13 wherein it covers an area dimension of 26 inches in width and 12 inches in length.

17. The said coating specific of claim 14 wherein it covers an area dimensions of 26 inches in width and 12 inches in length.

18. The said coating specific of claim 16 is positioned in a specific configuration wherein a distance between the bottom of the upper section and the top of the lower section is 35 inches.

19. The said configuration of the coating of claim 16 is designed to accommodate users of different heights ranging from a 5 foot tall person to a 6 foot 6 inches tall person without losing on the functionality of providing grips for both their palms and feet.

20. The said custom cut exercise mat of claim 1 is configured for different exercises wherein a standard yoga exercise mat with dimension 26 inches by 71 inches is different from other custom cut mats for other floor exercises.

21. The said custom cut exercise mat of claim 1 is configured for different shapes and sizes for exercise machines wherein the paddle shape and dimension of 24 inches by 40 inches is specific for a pilates machine.

22. The said custom cut exercise mat of claim 21 is configured with a plain surface wherein there is no coating.

23. The said custom cut exercise mat of claim 21 is configured with a surface wherein there is a coating.

24. The said custom cut exercise mat for machines specific of claim 22 is configured with a surface wherein it absorbs sweaty palms and sweaty back.

25. The said coating specific of claim 23 has a configuration wherein covering an area wherein palms or back touch the surface while performing different exercise routines.

26. The said configuration specific of claim 25 has a coating wherein the coated area with the felt dots with area dimensions of 16 inches by 20 inches specific for pilates machine.

27. A method for fabricating a custom cut exercise mat configured as a machine washable dryable exercise mat of multilayered arrangement comprising:
a. Integrating three layers of fabric by applying heat and adhesive wherein a facing first layer soft fabric is an absorbent surface allowing sweat to be absorbed and preventing liquid stagnation, a wicking second layer wherein the second layer instantly dissipates any liquid by making the facing fabric dry quickly and a protective barrier third layer wherein the third layer is preventing liquid from seeping through thereby protecting a surface that it is used on;
b. Attaching the integrated layers with a cushioning fourth layer wherein the fourth layer is maintaining a thickness for comfort;
c. Coating a bottom anti-skid layer with silicone and applying dots wherein the bottom layer has a special anti-skid coating with dots preventing skidding on the surface that it is used on.

28. The said method of claim 27 wherein applying felt dots to the facing fabric surface as a variation method wherein the dots are protruding slightly from the surface providing a firm grip for a user.

29. The said method of claim 28 wherein a pattern with an upper section and a lower section of dots are applied with specific dimensions of 26 inches in width and 12 inches in length wherein a distance between the bottom of the upper section and the top of the lower section is 35 inches.

30. The said method of claim 27 wherein cutting the multilayered arrangement in a desired shape and dimension for specific applications, a standard yoga mat of 26 inches wide by 71 inches long dimensions or a paddle shaped pattern custom cut for a pilates machine of 24 inches by 40 inches long dimensions.
